(19) United States
(12) Patent Application Publication
(10) Pub. No.: US 2010/0295528 A1
(43) Pub. Date: Nov. 25, 2010

(54) CIRCUIT FOR DIRECT GATE DRIVE CURRENT REFERENCE SOURCE

(75) Inventors: Bok Ju PARK, Suwon-si (KR); Si Bum Jun, Hwaseong-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/779,598

(22) Filed: May 13, 2010

(30) Foreign Application Priority Data
May 19, 2009 (KR) 10-2009-0043344

(51) Int. Cl. G05F 3/16

(52) U.S. Cl. 323/312

(57) ABSTRACT

A direct gate drive current reference source circuit is provided. The direct gate drive current reference source circuit includes a reference voltage generation core outputting a reference voltage of constant magnitude and a transistor directly receiving the reference voltage from the reference voltage generation core, without a resistor between the transistor and a ground.

### PRIORITY

This application claims priority under 35 U.S.C. §119(a) to a Korean Patent Application filed in the Korean Intellectual Property Office on May 19, 2009, and assigned Serial No. 10-2009-0043344, the entire disclosure of which is incorporated herein by reference.

### BACKGROUND OF THE INVENTION

1. Field of the Invention

The present invention generally relates to a circuit for a direct gate drive current reference source, and more particularly, to a design of a direct gate drive current reference source circuit providing a reference current to all blocks of a Radio Frequency (RF) transceiver Integrated Circuit (IC) for an RF communication terminal.

2. Description of the Related Art

Generally, a Zero Temperature Coefficient (ZTC) current reference generation source which outputs a current of constant magnitude without being influenced by temperature, a Proportional To Absolute Temperature (PTAT) current source which outputs a current proportional to absolute temperature, and a Counter To Absolute Temperature (CTAT) current source which outputs a current complementary temperature to absolute are used for a reference bias circuit (e.g., bandgap circuit). However, each type of application block requires different current characteristics with respect to temperature according to type. The foregoing current sources are selectively used according to current characteristics requested by respective application blocks.

A conventional ZTC current source using a bandgap reference voltage generation core generates a current of a ZTC through an operational amplifier (OP-AMP) based voltage-current conversion circuit using a voltage output from the bandgap reference voltage generation core. The conventional OP-AMP based voltage-current conversion circuit is shown in FIG. 1.

Further, a conventional PTAT current source generates a current using temperature proportional characteristics of a current generated by applying a base-emitter voltage difference of two bipolar devices having different densities to a resistor. The conventional PTAT current source is shown in FIG. 2.

Both the current source circuit of FIG. 1 and the current source circuit of FIG. 2 include a resistor, 130 and 210, respectively.

A device manufactured by implementing a resistor in a silicon wafer using Sub-Micron Silicon Process technology can have a component deviation to a maximum 20%. The ZTC current source, the PTAT current source, and the CTAT current source providing a bias reference current to each block of an RF transceiver IC may also have an error of a significant size when a process of reducing a component deviation is not performed. Accordingly, in a field requiring precision device manufacture, an additional process for reducing the component deviation should be performed, thereby increasing the cost and time.

Accordingly, it is necessary to provide a current reference source capable of providing a reference current to all kinds of core function blocks without the need to use a resistor.

### SUMMARY OF THE INVENTION

The present invention has been made in view of the above problems, and provides a current reference source such as a ZTC current source, a PTAT current source, or a CTAT current source, but without a resistor.

In accordance with an aspect of the present invention, a direct gate drive current reference source circuit includes a reference voltage generation core outputting a reference voltage of constant magnitude; and a transistor directly receiving the reference voltage from the reference voltage generation core, wherein a resistor is not provided between the transistor and a ground.

In accordance with another aspect of the present invention, a direct gate drive variable slope current reference source circuit includes a reference voltage generation core outputting a reference voltage of constant magnitude; at least two transistors receiving the reference voltage from the reference voltage generation core; and at least two switches respectively connected to the at least two transistors to be closed or open according to a control signal, wherein the at least two transistors have different sizes and are connected to each other in parallel.

In accordance with another aspect of the present invention, a direct gate drive zero temperature coefficient current reference source circuit includes a first reference voltage generation core that outputs a first reference voltage of constant magnitude; a second reference voltage generation core that outputs a second reference voltage of constant magnitude; a first transistor that receives the first reference voltage from the first reference voltage generation core; and a second transistor that receives the first reference voltage from the second reference voltage generation core, wherein the first transistor and the second transistor are connected to each other in parallel, the first reference voltage is equal to or greater than a preset voltage, and the second reference voltage is less than the preset voltage.

In accordance with another aspect of the present invention, a current reference source circuit includes a variable slope current source that outputs a current proportional or inversely proportional to temperature according to a select signal; and an offset current source that offsets the current output from the variable slope current source to be a constant nominal current, wherein the variable slope current source and the offset current source are connected to each other in series.

Since the current reference source does not use a resistor when generating a current, a component deviation which otherwise inevitably occurs during a silicon wafer manufacturing process may be improved. Further, since a separate process for reducing the component deviation is not necessary, unlike conventional systems, the cost and manufacturing time due to the generation of a current source may be reduced. In addition, since the present invention is designed without a resistor, a silicon layout area may be reduced.

### BRIEF DESCRIPTION OF THE DRAWINGS

The objects, features and advantages of the present invention will be more apparent from the following detailed description in conjunction with the accompanying drawings, in which:

FIG. 1 illustrates a configuration of a conventional ZTC current source using a bandgap reference voltage generation core;

FIG. 2 illustrates a configuration of a conventional PTAT current source circuit;

FIG. 3A illustrates a configuration of a direct gate drive current reference source having functions of a PTAT current source and a CTAT current source according to an embodiment of the present invention;

FIG. 3B illustrates a configuration of a direct gate drive current reference source having a mirror circuit according to an embodiment of the present invention;

FIGS. 4B and 4B are charts illustrating a temperature characteristic of current generated by a direct gate drive current reference source according to an embodiment of the present invention;

FIG. 5 illustrates an embodiment of a configuration of a direct gate drive variable slope current reference source according to the present invention;

FIG. 6 is a chart of temperature versus current generated when a gate-to-source voltage less than 0.75V is applied to the direct gate drive variable slope current source shown in FIG. 5;

FIG. 7 is a chart of temperature versus current generated when gate-to-source voltage greater than or equal to 0.75V is applied to the direct gate drive variable slope current source shown in FIG. 5;

FIG. 8 illustrates a configuration of a direct gate drive ZTC current source according to an embodiment of the present invention;

FIG. 9 is a chart of temperature versus current generated when reference voltages having different magnitudes are applied to respective transistors of the direct gate drive ZTC current source shown in FIG. 8;

FIG. 10 illustrates a configuration of a direct gate drive variable slope current source having a constant nominal current;

FIG. 11 is a illustrates an overall configuration of the direct gate drive variable slope current source having a constant nominal current shown in FIG. 10; and

FIG. 12 is a chart illustrating a temperature characteristic of current generated by the direct gate drive variable slope current source having a constant nominal current shown in FIG. 11.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

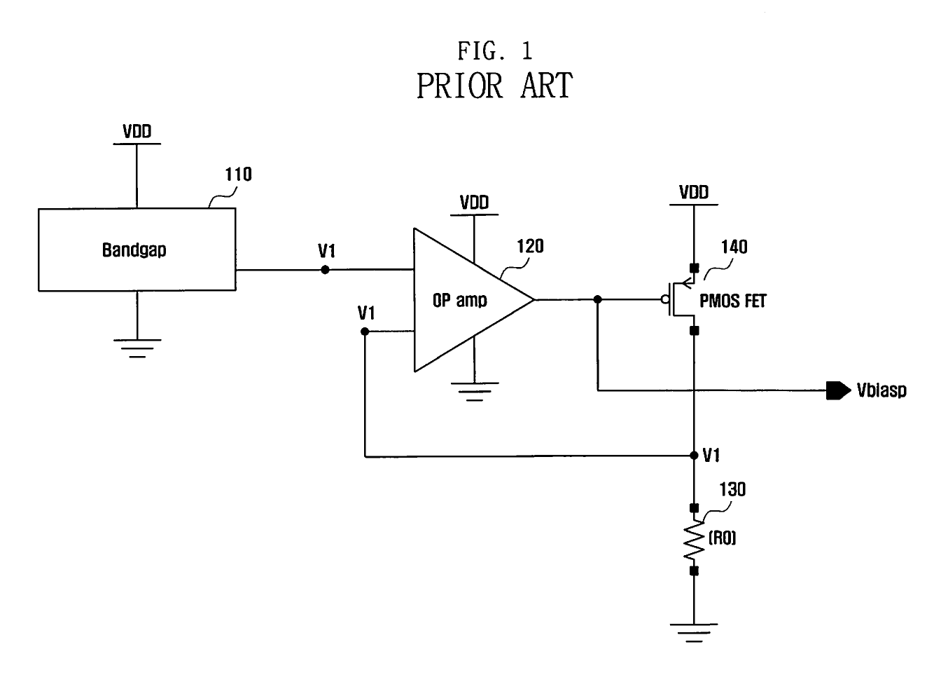

FIG. 1 illustrates a conventional ZTC current source using a bandgap reference voltage generation core. The bandgap reference voltage generation core shown in FIG. 1 is a circuit outputting a constant voltage independent of variations in temperature, supply voltage, and process. The bandgap reference voltage generation core outputs a voltage V1(V) of constant magnitude. Next, the output voltage V1 is sent to a resistor R0 130 by a buffering function of an OP amplifier 120.

Accordingly, a current is generated between the resistor R0 130 and a transistor 140, according to Equation (1).

$$I = \frac{V 1}{R 0} \qquad ( 1 )$$

In this case, because the resistor R0 used for the ZTC current source does not have a different cancellation factor allowing deviation compensation, the ZTC current source designed using the resistor R0 has an abnormal component deviation unless layout matching is performed.

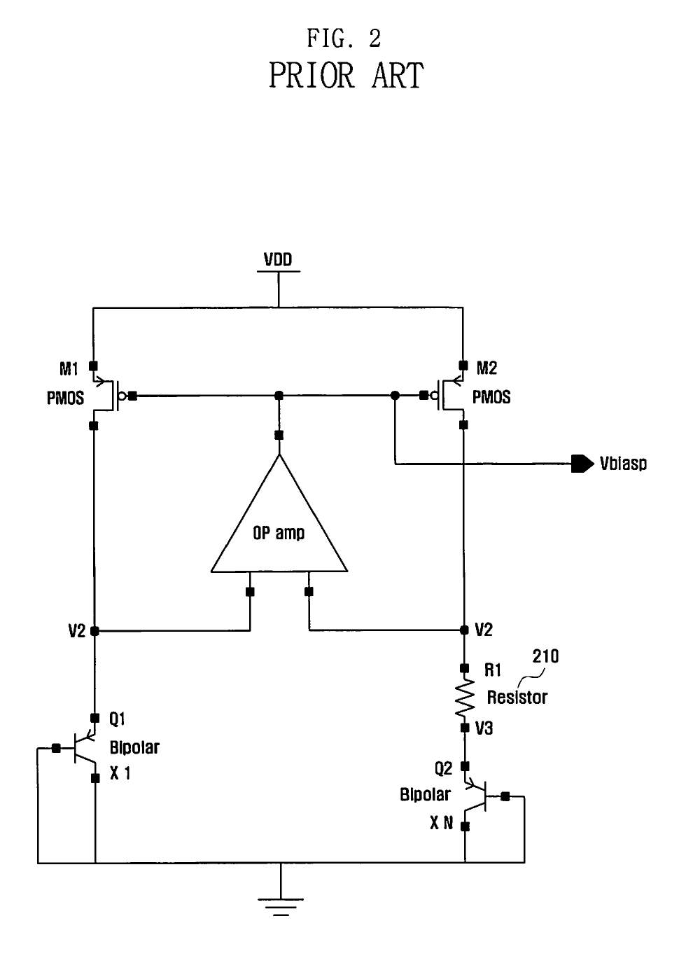

FIG. 2 illustrates a configuration of a conventional PTAT current source circuit. Referring to FIG. 2, voltages V2 and V3 are generated across a resistor R1 210 of the PTAT current source circuit, respectively. Accordingly, a current I is generated through the resistor R1 210, according to Equation (2).

$$I = \frac{V 2 - V 3}{R 1} \qquad ( 2 )$$

As illustrated in Equation (2), the resistor R1 210 is included in the PTAT current source. As in FIG. 1, there is not a different cancellation factor allowing deviation compensation. A PTAT current source designed using a resistor R1 has a component deviation, which is identical with the case of the PTAT current source.

Consequently, there is a demand for a method that may design a ZTC current source, a PTAT current source, and a CTAT current source without using a resistor.

### First Embodiment

The following is a description of a direct gate drive current reference source having both functions of a PTAT current source and a CTAT current source without using a resistor according to a first embodiment of the present invention.

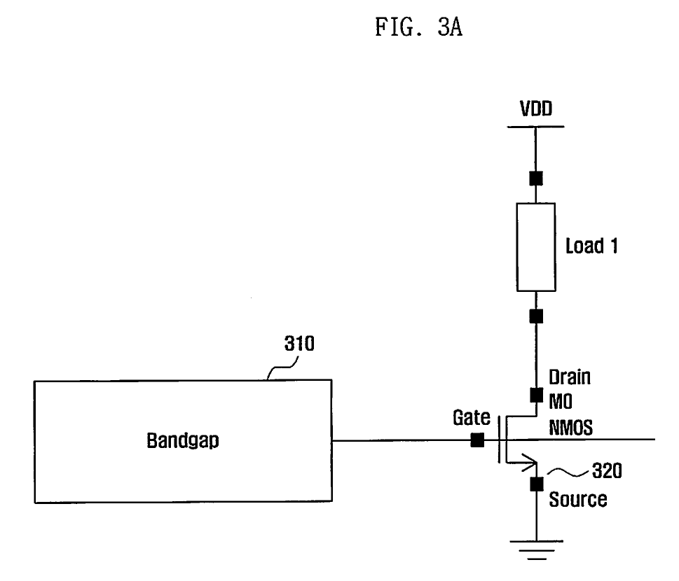

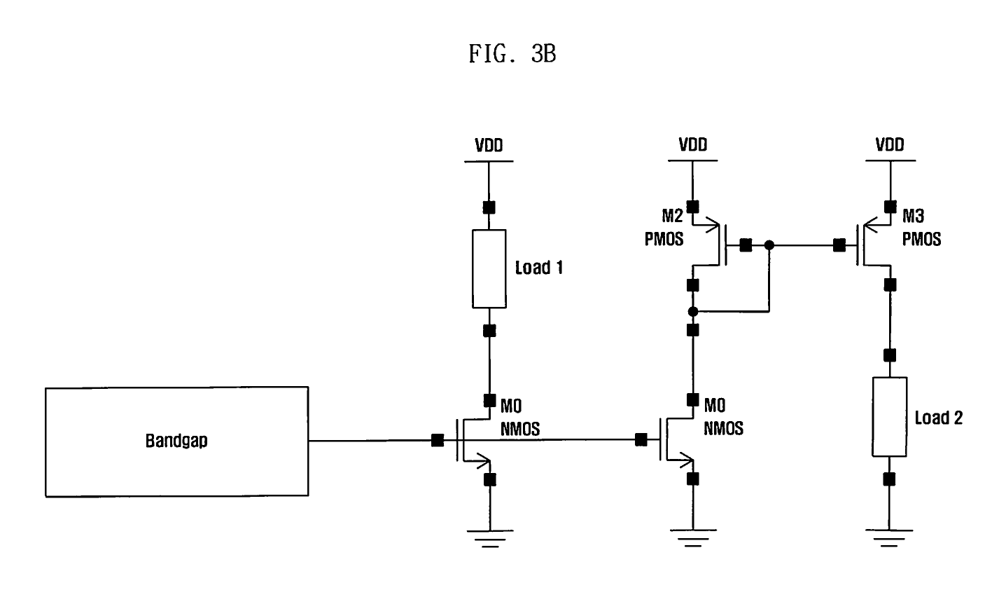

FIG. 3A illustrates a configuration of a direct gate drive current reference source with functions of a PTAT current source and a CTAT current source according to an embodiment of the present invention.

The direct gate drive current reference source according to an embodiment of the present invention includes a reference voltage generation core 310 and a transistor 320. A reference voltage generated by the reference voltage generation core 310 is directly input to the transistor 320, which is referred to as a direct gate drive method in this embodiment. Further, a resistor is not provided between the transistor 320 and a ground. Hereinafter, it is assumed that the reference voltage generation core is a bandgap reference voltage generation core.

The bandgap reference voltage generation core 310 is a circuit outputting a constant voltage independent of variations in temperature, supply voltage, and manufacturing process change. In an embodiment of the present invention, the bandgap reference voltage generation core 310 supplies an output reference voltage as a drive voltage of the transistor 320.

The transistor 320 receives a voltage output from the band gap reference voltage generation core 310 as a drive voltage to generate a current. In an embodiment of the present invention, the transistor 320 is preferably a metal-oxide semiconductor field effect transistor (MOS-FET). A drain-to-source current is determined in the MOS-FET 320 when operating in a saturation region by Equation (3).

$${I}_{DS} = \frac{1}{2} μ {C}_{OX} \frac{W}{L} {( {V}_{GS} - {V}_{th} )}^{2} \qquad ( 3 )$$

In Equation (3) for the drain-to-source current, factors influenced by temperature are a threshold voltage Vₜₕ and a mobility μ. The influences of the threshold voltage Vₜₕ and the mobility p due to temperature variables may be expressed by Equation (4).

$${V}_{th} ( T ) = {V}_{th} ( {T}_{O} ) - k ( T - {T}_{O} ) \\ μ ( T ) = μ ( {T}_{O} ) {( \frac{T}{{T}_{O}} )}^{- m} \qquad ( 4 )$$

wherein a coefficient value k of the threshold voltage has a typical value of 2.5 mV/K, and a temperature coefficient m of the mobility μ has a typical value of 1.5. Accordingly, when the temperature is increased by 100 degrees Celsius, the threshold voltage Vₜₕ is reduced by 0.25 and the mobility μ is reduced by approximately 35%.

In this case, when a current generated in the drain-to-source is observed after a voltage is applied to a gate-to-source of the MOS-FET, a resulting change is obtained according to the magnitude of gate-to-source voltage in temperature characteristics.

Namely, when the gate-to-source voltage is equal to or greater than 0.75V, a reduced amount of current due to a mobility reduction is larger than an increased amount of the current due to a reduction of a threshold voltage according to an increase in temperature. Accordingly, the total drain-source current has a tendency to be reduced according to the increase temperature. That is, the drain-source current has a negative temperature coefficient characteristic inversely proportional to the temperature increase.

Meanwhile, when the gate-to-source voltage is less than 0.75V, an increased amount of current due to a reduced threshold voltage is larger than a reduced amount of current due to a mobility reduction according to a temperature increase. Accordingly, the total drain-source current has a tendency to increase according to the temperature increase. That is, the drain-source current has a positive temperature coefficient characteristic proportional to the temperature increase.

In summary, the direct gate drive current reference source shown in FIG. 3A may operate as a PTAT current source or a CTAT current source according to the magnitude of the gate-to-source voltage. Namely, when the gate-to-source voltage is less than 0.75V, the direct gate drive current reference source operates as the PTAT current source. Conversely, when the gate-to-source voltage is greater than or equal to 0.75V, the direct gate drive current reference source operates as the CTAT current source.

Accordingly, the direct gate drive current reference source of the present invention can be used as the PTAT current source or the CTAT current source by changing the magnitude of a voltage applied to the gate-to-source. Further, since the direct gate drive current reference source of the present invention does not use a resistor, it reduces component deviation of a current source without layout matching, thereby providing a highly stable reference current.

FIG. 3B illustrates a configuration of a direct gate drive current reference source having a mirror circuit according to an embodiment of the present invention. A current generated by the direct gate drive current reference source, if necessary, may be amplified and provided to respective function blocks using the mirror circuit shown in FIG. 3B.

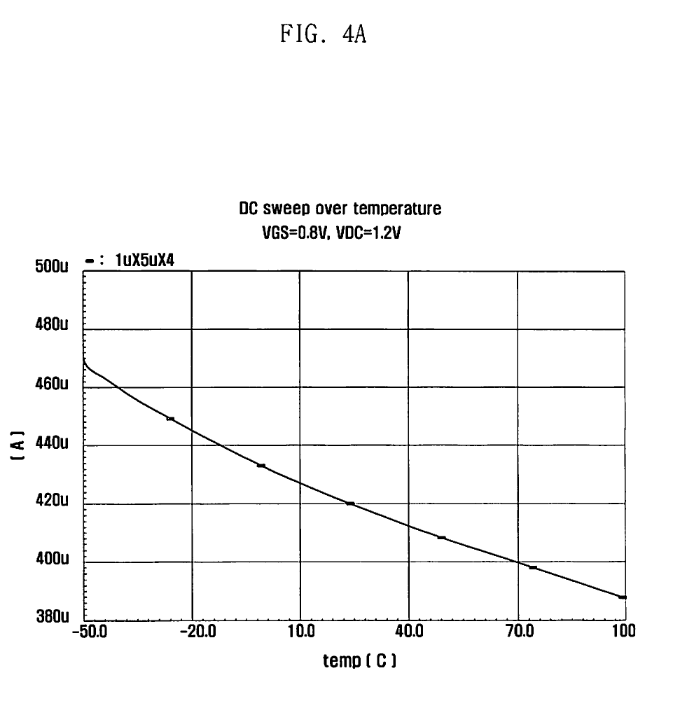

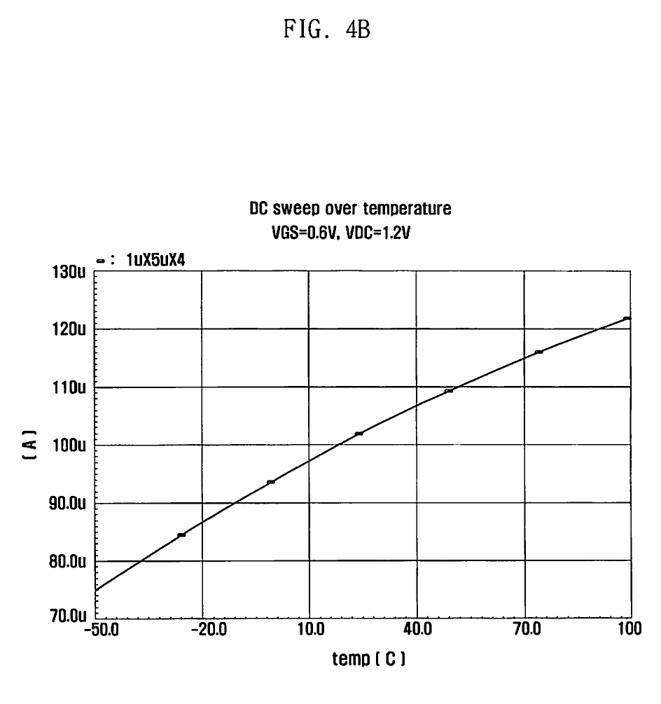

FIGS. 4A and 4B are charts illustrating a temperature characteristic of current generated by a direct gate drive current reference source according to an embodiment of the present invention. Transistor used in FIGS. 4A and 4B are a NMOS-FET preferably of a size of 1 u×5 u×4.

In FIG. 4A, when a voltage greater than or equal to 0.75V is applied to a gate-to-source, it is appreciated that current generated by the direct gate drive current reference source is reduced inversely proportional to the temperature rise. Namely, it may be understood that the direct gate drive current reference source in this case operates as a CTAT current source.

In the meantime, referring to FIG. 4B, when a voltage less than 0.75V is applied to the gate-to-source, it is appreciated that current generated by the direct gate drive current reference source increases in proportion to the temperature rise. Namely, it may be understood that the direct gate drive current reference source in this case operates as a PTAT current source.

### Second Embodiment

The following is a description of a direct gate drive current reference source having a variable slope without using a resistor according to a second embodiment.

Degradation due to temperature rise may be changed in all application block types of an RF transceiver IC of the present invention. For example, the degradation degree due to the same rise of temperature will differ in an amplifier, a mixer, an oscillator, and the like. Consequently, to equally compensate for such different degradations due to the same rise of temperature, it is necessary to provide current of different magnitudes. As a result, it is necessary to design a variable slope current source generating a current having different slopes with variations in temperature.

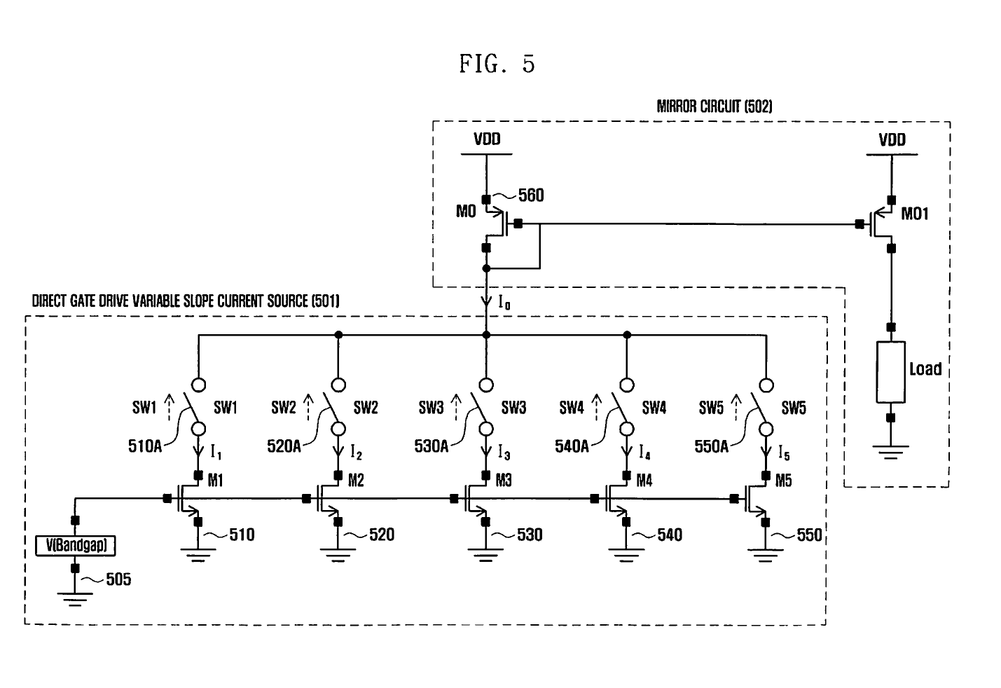

In order to implement the direct gate drive variable slope current source, two methods may be considered. A first method is to generate a drain-source current by changing gate-to-source voltage. In a second method, a plurality of MOS-FETS having different sizes are arranged in parallel, and only necessary FETS are turned-on to sum currents flowing through respective sources-drains, thereby obtaining a variable slop characteristic. FIG. 5 shows a direct gate drive variable slope current reference source implemented using the second method.

Referring to FIG. 5, a current generated by the direct gate drive variable slope current reference source 501 is provided to respective function blocks through a mirror circuit 502.

In the direct gate drive variable slope current reference source shown in FIG. 5, a plurality of MOS-FETS 510 to 550 are arranged in parallel, and the same voltage is applied to the plurality of MOS-FETS 510 to 550. Here, “parallel” means that terminals with the same polarity are connected to each other. Namely, in a case of MOS-FET, when drains having the same polarity are connected to each other, it can be defined as parallel connection. Further, a voltage applied to the transistor may be provided from a bandgap reference voltage generation core 505.

Moreover, the plurality of transistors 510 to 550 may be respectively connected to switches 510A to 510A, and can be turned-on and turned-off according to a switch control signal.

If only the switch SW1 510A is turned-on, a current I0 flowing through the transistor 560 is identical with a current I1 flowing through the first transistor 510. Further, if only the switch SW2 510B is turned-on, the current I0 flowing through the transistor 560 is identical with a current I₂ flowing through the second transistor 520. In this way, when a plurality of transistors having a different size are connected to each other in parallel, and respective transistors are turned-on or turned-off, a current reference source having a slope of a desired magnitude can be generated.

Meanwhile, it is possible to simultaneously turn-on switch SW1 510A and switch SW2 5108. In this case, the current I₀ flowing through the transistor 560 is identical with a sum (I₁+I₂) of the current I₁ flowing through the transistor 510 and the current I₂ flowing through the transistor 520. Upon using the foregoing method, a current reference source having various slopes may be generated.

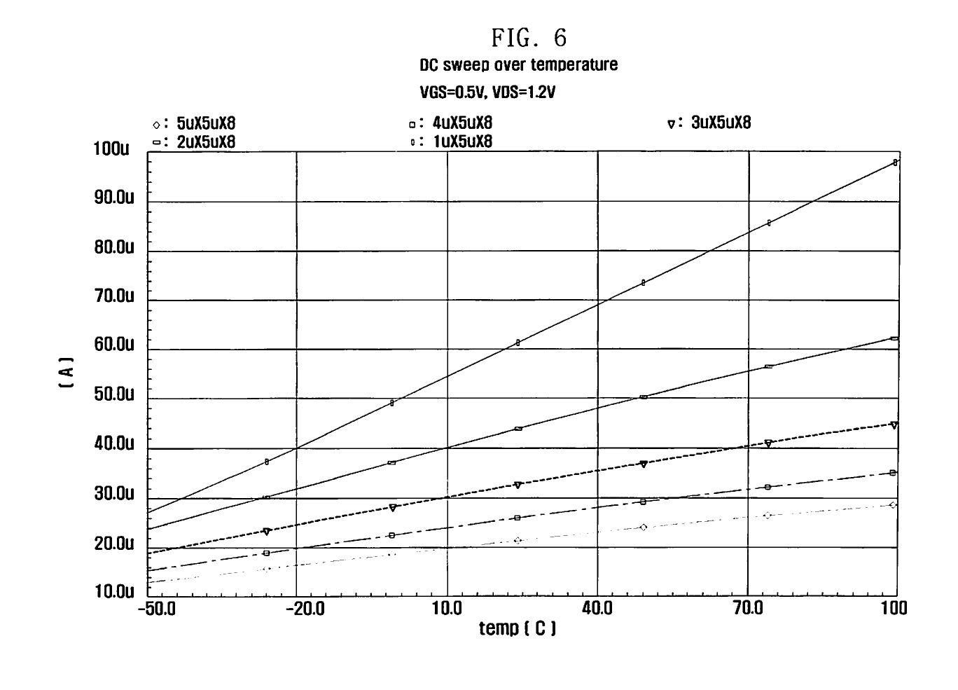

FIG. 6 is a chart of temperature versus current generated when a gate-to-source voltage less than 0.75V is applied to the direct gate drive variable slope current source shown in FIG. 5.

In FIG. 6, five MOS-FETS having sizes of 1 u×5 u×8, 2 u×5 u×8, 3 u×5 u×8, 4 u×5 u×8, and 5 u×5 u×8 are arranged in parallel. When gate-to-source voltage of 0.5V is applied, the amount of current varies by sequentially turning-on switch SW1 to switch SW5.

It may be appreciated in FIG. 6 that the amount of current increases in proportion to the increase of temperature and to the increase in transistor size when a voltage of 0.5V being less than 0.75V is applied to the transistor. Namely, a direct gate drive variable slope current source in this case operates as a PTAT current source.

Here, a current generated by the direct gate drive variable slope current source may be expressed by Equation (5).

I_{DSPTAT}=M×(T^{m}I₀+I₀) (5)

where M is a Device Size Scale Factor (DSSF), which can be determined according to the size of a transistor 560 in a mirror circuit.

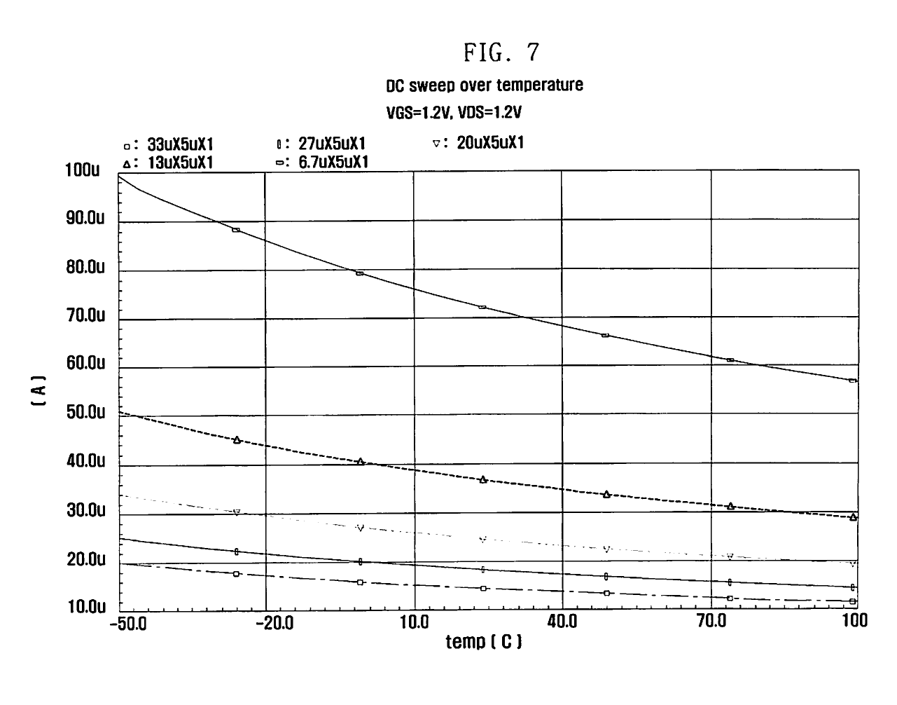

In the meantime, FIG. 7 is a chart of temperature versus current generated when gate-to-source voltage equal to or greater than 0.75V is applied to the direct gate drive variable slope current source shown in FIG. 5. FIG. 7 illustrates a current amount which varies by sequentially turning-on switch SW1 to switch SW5, when five MOS-FETS having the sizes of 6.7 u×5 u×1, 20 u×5 u×8, 33 u×5 u×8, 27 u×5 u×1, 13 u×5 u×1 are arranged in parallel and gate-to-source voltage of 1.2V is applied.

It may be appreciated in FIG. 7 that the amount of current decreases in an inverse proportion to the increase of temperature and to the increase in transistor size, when a voltage of 1.2V being equal to or greater than 0.75V is applied to the transistor.

Namely, a direct gate drive variable slope current source in this case operates as a CTAT current source.

Here, a current generated by the direct gate drive variable slope current source may be expressed by Equation (6).

I_{DSCTAT}=N×(T^{-k}I₀+I₀) (6)

where N is the DSSP, which can be determined according to the size of a transistor in a mirror circuit.

### Third Embodiment

The following is a description of a direct gate drive current reference source with a ZTC without using a resistor according to a third embodiment.

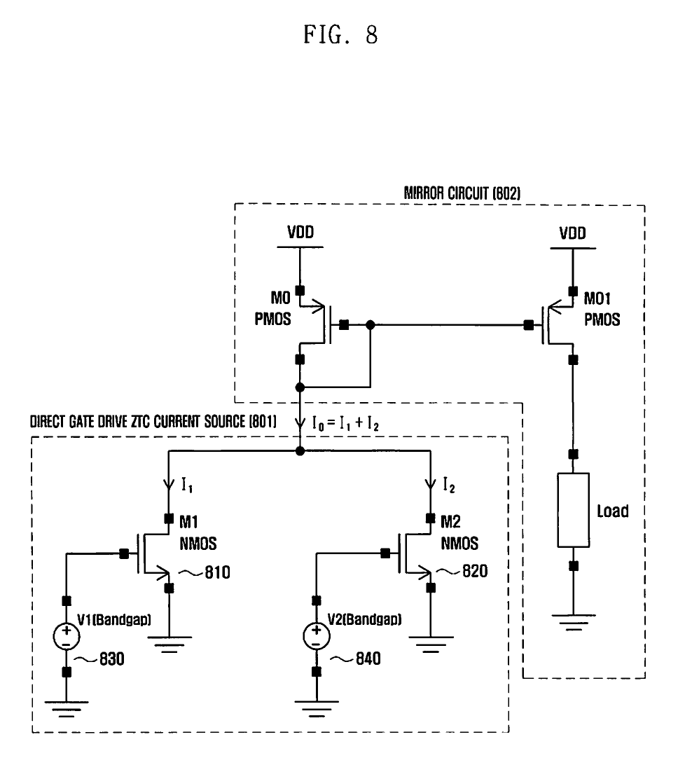

FIG. 8 illustrates a configuration of a direct gate drive ZTC current source according to the present invention. Referring to FIG. 8, a current generated by the direct gate drive ZTC current source 801 is supplied to respective function blocks through a mirror circuit 802.

In the direct gate drive ZTC current source of the present invention, two MOS-FETS having different sizes are arranged in parallel, and voltages having different magnitudes are applied to gate-source of respective transistors.

In detail, in the direct gate drive ZTC current source 801, a first transistor 810 to which a first reference voltage 830 is applied and a second transistor 820 to which a second reference voltage 840 is applied are arranged in parallel, and current generated in each respective transistors are summed to generate a current having a ZTC characteristic. The current generated in the direct gate drive ZTC current source is a sum (I1+I2) of the current I1 flowing through the first transistor 810 and the current I2 flowing through the second transistor 820.

Meanwhile, one of the first reference voltage 830 and the second reference voltage 840 is set to be greater than or equal to 0.75V, and the other is set to be less than 0.75V. A transistor connected to a reference voltage equal to or greater than 0.75V generates a current inversely proportional to temperature, whereas a transistor connected to a reference voltage less than 0.75V generates a current proportional to temperature. Accordingly, the currents are summed to generate a current having a certain magnitude.

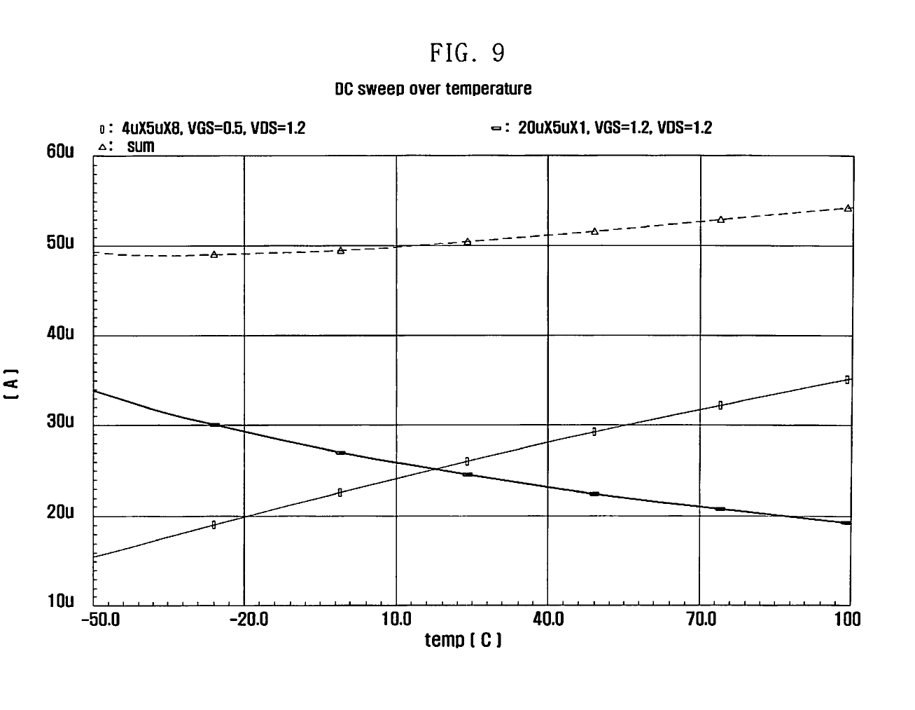

FIG. 9 is a chart of temperature versus current generated when reference voltages having different magnitudes are applied to respective transistors of the direct gate drive ZTC current source shown in FIG. 8. FIG. 9 illustrates a sum of currents flowing through respective transistors, when a first reference voltage 830 is 0.5V, a second reference voltage 840 is 1.2V, the size of a first transistor 810 is 4 u×5 u×8, and the size of a second transistor 820 is 20 u×5 u×1.

Referring to FIG. 9, it is understood that a sum of the currents flowing through the first transistor 810 and the second transistor 820 has a constant value since the current generated in the first transistor 810 is proportional to temperature and the current generated in the second transistor 820 is inversely proportional to the temperature. In this case, magnitudes of the first reference voltage 830 and the second reference voltage 840, and the sizes of the first transistor 810 and the second transistor 820 to have a ZTC characteristic may be determined by experimental values.

Here, the characteristic of current generated by the direct gate drive ZTC current source can be expressed by Equation (7).

$$\begin{matrix}{I}_{DSZTC} = M \times ( {T}^{m} {I}_{0} + {I}_{0} ) + N \times ( {T}^{- k} {I}_{0} + {I}_{0} ) \\ = ( {MT}^{m} + {NT}^{- k} + M + N ) {I}_{0} \\ = α {I}_{0}\end{matrix} \qquad ( 7 )$$

where, α can be determined to make a temperature coefficient of zero in a specific temperature (i.e., room temperature) in such a manner that a variation amount of a becomes zero in response to temperature by adjusting current scale factors M and N.

### Fourth Embodiment

The following is a description of a direct gate drive current reference source having a ZTC and a constant nominal current according to a fourth embodiment. Here, the nominal current means a current generated in a device in a specific temperature.

In a characteristic of the direct gate drive variable slope current source expressed by Equation (5) or Equation (6) of the second embodiment, as the size of a transistor changes, a slope (M×T^{m} or N×T^{-k}) varies, and simultaneously a scale (M×I₀ or N×I₀) is also achieved for the magnitude of the nominal current. Accordingly, the fourth embodiment provides a direct gate drive variable slope current source in which a nominal current is fixed in a specific temperature and only the slope of a current variation has a variable characteristic.

To do this, if the scaled nominal current (M×I₀ or N×I₀) expressed in Equation (5) or Equation (6) is offset by the magnitude of (M−1)×I₀ or (N−1)×I₀, a constant nominal current I₀ may be maintained. A procedure of offsetting a current of specific magnitude may be performed by the direct gate drive ZTC current source according to the third embodiment.

Namely, a gain of a ZTC current source obtained by Equation 7 is re-scaled, so that an current is identical with (M−1)×I₀ or (N−1)×I₀ ([N′×α×I₀=(M−1)×I₀ or (N−1)×I₀). Next, if the re-scaled gain of the ZTC current source is subtracted from Equation (5) or Equation (6), the current may be expressed by Equation (8).

$$\begin{matrix}{I}_{DSPTAT}^{′} = M \times ( {T}^{m} {I}_{0} + {I}_{0} ) - {N}^{′} \times α {I}_{0} \\ = M \times ( {T}^{m} {I}_{0} + {I}_{0} ) - ( M - 1 ) {I}_{0} \\ = M \times {T}^{m} {I}_{0} + {I}_{0}\end{matrix} \\ \begin{matrix}{I}_{DSCTAT}^{′} = N \times ( {T}^{- k} {I}_{0} + {I}_{0} ) - {N}^{′} \times α {I}_{0} \\ = N \times ( {T}^{- k} {I}_{0} + {I}_{0} ) - ( N - 1 ) {I}_{0} \\ = N \times {T}^{- k} {I}_{0} + {I}_{0}\end{matrix} \qquad ( 8 )$$

Equation (8) indicates that a temperature slope is scaled (M×T^{m} or N×T^{-k}), but a nominal current is constant (I₀) in the direct gate drive variable slope current source.

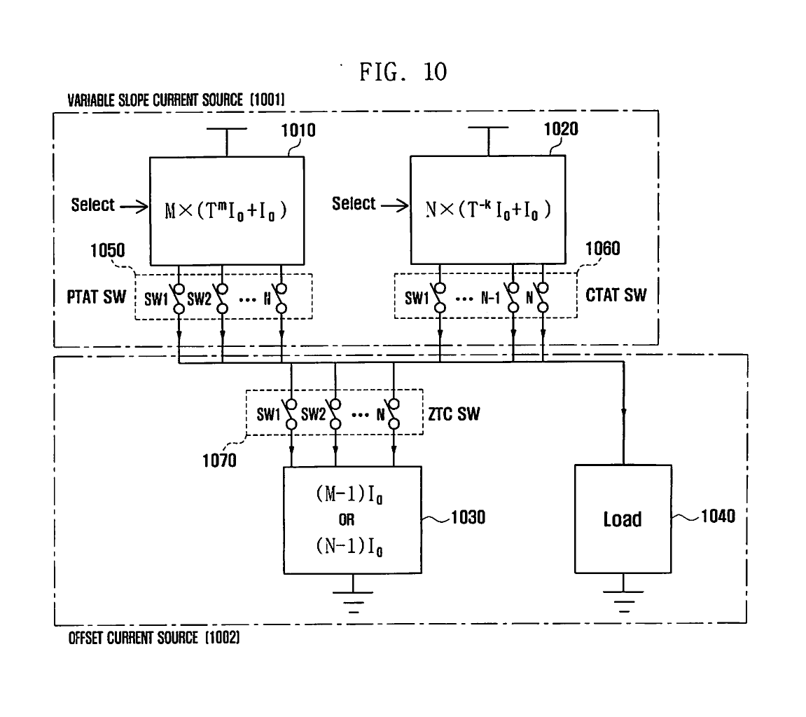

FIG. 10 is a block diagram illustrating a configuration of a direct gate drive variable slope current source having a constant nominal current.

Referring to FIG. 10, the direct gate drive variable slope current source includes a variable slop current source 1001, an offset current source 1002, and a load 1040. The variable slope current source 1001 operates as a PTAT current source 1010 or a CTAT current source 1020, and includes a PTAT switch unit 1050 and a CTAT switch unit 1060. The offset current source 1002 includes at least two ZTC current sources 1030 and a ZTC switch unit 1070.

The direct gate drive variable slope current source shown in FIG. 10 operates as a PTAT current source or a CTAT current source having a constant nominal current according to a user's control, i.e. select signal. In the present invention, a voltage signal less than 0.75V may be used as a select signal for operating the direct gate drive variable slope current source as the PTAT current source, and a voltage signal greater than or equal to 0.75V may be used as the select signal for operating the direct gate drive variable slope current source as the CTAT current source. In an embodiment of the present invention, respective switch states of the PTAT switch unit 1050 are identical with respective switch states of the CTAT switch unit 1070. For example, when switches SW1 and SW2 of the PTAT switch unit 1050 are turned-on and remaining switches are turned-off, switches SW1 and SW2 of the CTAT switch unit 1070 are turned-on and remaining switches are turned-off.

Accordingly, among a current M×(T^{m}I₀+I₀) generated by the PTAT current source 1010, since a current (M−1)×I₀ is provided to the ZTC current source 1030, and remaining currents M×(T^{m}I₀+I₀) flow through the load 1040, the direct gate drive variable slope current source shown in FIG. 10 generates a nominal current I₀ which is always constant.

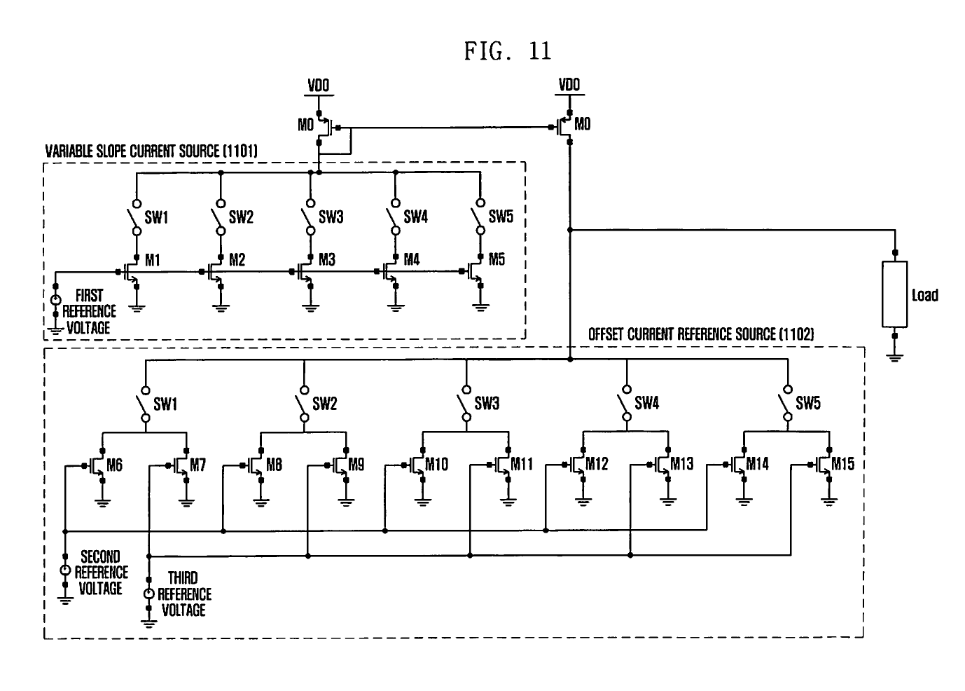

FIG. 11 illustrates an overall configuration of the direct gate drive variable slope current source shown in FIG. 10. In the direct gate drive variable slope current source shown in FIG. 11, a variable slope current source 1101 and an offset current source 1102 are connected in series.

The variable slope current source 1101 of FIG. 11 operates as a PTAT current source or a CTAT current source corresponding to the current source shown in FIG. 5. The offset current source 1102 corresponds to a plurality of ZTC current sources shown in FIG. 8. A principle of operation of the direct gate drive variable slope current source having a constant nominal current is identical with that of FIG. 10, and is not repeated here for conciseness.

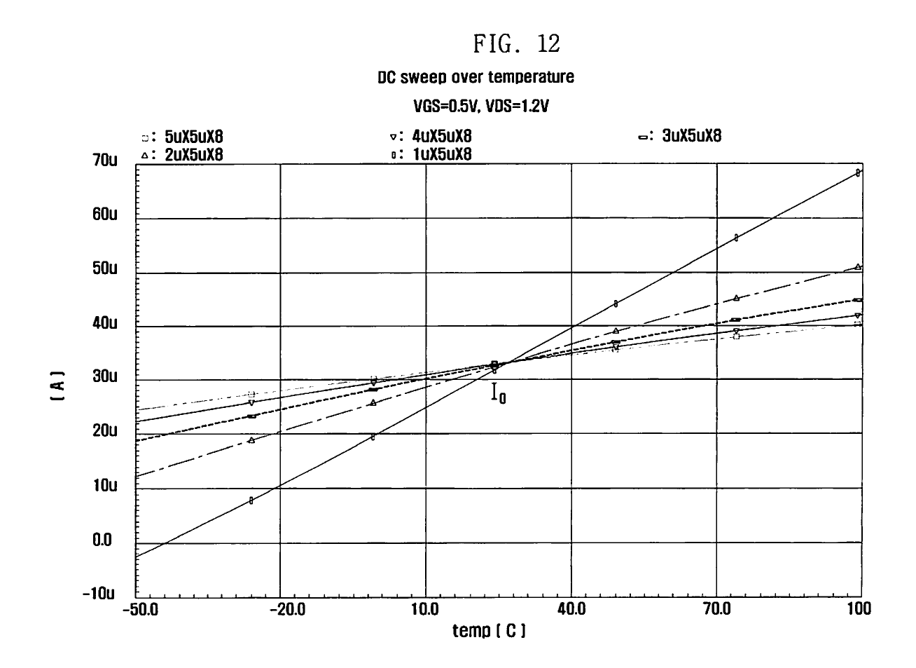

FIG. 12 is a chart illustrating a temperature characteristic of current generated by the direct gate drive variable slope current source having a constant nominal current shown in FIG. 11.

In FIG. 12, it can be appreciated that the direct gate drive variable slope current source has a nominal current of 33 uA at 27□, the nominal current is fixed and a temperature slope varies according to the size of a transistor.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A direct gate drive current reference source circuit comprising:
a reference voltage generation core that outputs a reference voltage of constant magnitude; and
a transistor that directly receives the reference voltage from the reference voltage generation core,
wherein a resistor is not provided between the transistor and a ground.

2. The direct gate drive current reference source circuit of claim 1, wherein the transistor generates a current proportional to temperature when a value of the reference voltage less than a preset voltage is input to the transistor, and the transistor generates a current inversely proportional to the temperature when the value of the input reference voltage is greater than or equal to the preset voltage.

3. The direct gate drive current reference source circuit of claim 2, wherein the preset voltage is 0.75V.

4. A direct gate drive variable slope current reference source circuit comprising:
a reference voltage generation core that outputs a reference voltage of constant magnitude;
at least two transistors that receive the reference voltage from the reference voltage generation core; and
at least two switches respectively connected to the at least two transistors, to close and open according to a control signal,
wherein the at least two transistors have different sizes and are connected to in parallel.

5. The direct gate drive variable slope current reference source circuit of claim 4, wherein a resistor is not provided between the transistor and a ground, the transistor generates a current proportional to temperature when an input reference voltage is less than a preset voltage, and the transistor generates a current inversely proportional to the temperature when the input reference voltage is greater than or equal to the preset voltage.

6. A direct gate drive zero temperature coefficient current reference source circuit comprising:
a first reference voltage generation core that outputs a first reference voltage of constant magnitude;
a second reference voltage generation core that outputs a second reference voltage of constant magnitude;
a first transistor that receives the first reference voltage from the first reference voltage generation core; and
a second transistor that receives the second reference voltage from the second reference voltage generation core,
wherein the first transistor and the second transistor are connected in parallel, the first reference voltage is greater than or equal to a preset voltage, and the second reference voltage is less than the preset voltage.

7. The direct gate drive zero temperature coefficient current reference source circuit of claim 6, wherein a resistor is not provided between either of the first or second transistors and a ground, the first and second transistors generate a current proportional to temperature when an input reference voltage is less than a preset voltage, and the transmitter generates an current inversely proportional to the temperature when the input reference voltage is greater than or equal to the preset voltage.

8. The direct gate drive zero temperature coefficient current reference source circuit of claim 7, wherein a size of the first transistor and a size of the second transistor are set so that a sum of a current generated by the first transistor and a current generated by the second transistor is constant.

9. A current reference source circuit comprising:
a variable slope current source that outputs a current proportional or inversely proportional to temperature according to a select signal; and
an offset current source that offsets the current output from the variable slope current source to provide a constant nominal current,
wherein the variable slope current source and the offset current source are connected in series.

10. The current reference source circuit of claim 9, wherein the variable slope current source includes:
a reference voltage generation core that outputs a reference voltage of constant magnitude;
at least two transistors that receive the reference voltage from the reference voltage generation core; and
at least two switches respectively connected to the at least two transistors, to close and open according to a control signal,
wherein the at least two transistors have different sizes and are connected in parallel.

11. The current reference source circuit of claim 10, wherein the offset current source includes at least two zero temperature coefficient current sources,
wherein the at least two zero temperature coefficient current sources each include:
a first reference voltage generation core that outputs a first reference voltage of constant magnitude;
a second reference voltage generation core that outputs a second reference voltage of constant magnitude;
a first transistor that receives the first reference voltage from the first reference voltage generation core; and
a second transistor that receives the second reference voltage from the second reference voltage generation core,
wherein the first transistor and the second transistor are connected in parallel, the first reference voltage is greater than or equal to a preset voltage, and the second reference voltage is less than the preset voltage.

12. The current reference source circuit of claim 11, wherein a resistor is not included between either of the first or second transistors and a ground, when the first and second transistors generate a current proportional to temperature when an input reference voltage is less than a preset voltage, and the first and second transistors generate a current inversely proportional to the temperature when the input reference voltage is greater than or equal to the preset voltage.

13. The current reference source circuit of claim 12, wherein the offset current source operates according to a switch operation of the variable slope current source, and further includes switches respectively connected to the at least two zero temperature coefficient current sources.
